(19) United States
(12) Patent Application Publication
(10) Pub. No.: US 2014/0014588 A1
(43) Pub. Date: Jan. 16, 2014

(54) METHOD FOR DEWATERING SLUDGE

(71) Applicants: Toine Koehorst, Zuid Beijerland (NL); Otto Schroers, Krefeld (DE)

(72) Inventors: Toine Koehorst, Zuid Beijerland (NL); Otto Schroers, Krefeld (DE)

(73) Assignee: Ashland Licensing and Intellectual Property LLC., Dublin, OH (US)

(21) Appl. No.: 13/982,625

(22) PCT Filed: Jan. 25, 2012
(86) PCT No.: PCT/EP2012/000327

§ 371 Date: Oct. 2, 2013

(30) Foreign Application Priority Data
Jan. 31, 2011 (EP) 11000741.6

(51) Int. Cl. C02F 11/14

(52) U.S. Cl. CPC C02F 11/14
USPC 210/709; 210/96.1

(57) ABSTRACT

The present invention relates to a method for dewatering of sludge, wherein an aqueous solution of polymeric flocculating agent is added to the sludge, wherein the sludge comprises a component to be removed by the flocculating agent being added to the sludge, wherein in order to limit the residual amount of the flocculating agent in a filtrate of the sludge the method comprises a first and/or a second step, wherein the first step comprises—measuring a first content information related to the total amount of solid material in the sludge (organic and inorganic)—measuring a second content information related to a sand material content in the sludge, wherein the first and second content information is used for controlling the addition of the aqueous solution of the polymeric flocculating agent to the sludge, wherein the second step comprises measuring a material information related to a material property of the filtrate, wherein the material information is used for controlling the content of the polymeric flocculating agent in the filtrate.

### FIELD OF THE INVENTION

The present invention relates to a method for dewatering of sludges, especially of sludges from rivers and harbors, by the use of polymeric flocculating agents.

### BACKGROUND OF RELATED TECHNOLOGY

Inorganic and organic sediments are constantly transported downstream by river currents. These sediments accumulate in the rivers and harbors.

These sediments can be removed from the water by dredgers. The sediments frequently contain environmentally hazardous constituents in the form, for example, of complexed heavy metal ions or hazardous organic substances, and so it is no longer permissible to dump them in deeper waters, as was frequently done in the past. Instead, they must be consigned to ultimate storage under environmentally safe conditions on land.

To permit proper ultimate storage, the sediments, which may contain up to 20 wt % of organic constituents depending on their origin, must be appropriately pretreated. In the method now being used in practice, the dredged sediment sludges are transported in barges to the facilities provided for sludge treatment and flushed at rates of 1000 to 6000 m³/h through pipelines to appropriate dewatering fields. Dewatering of the sludges takes place during sedimentation by seepage into drains, by draining off the supernatant water formed during sedimentation and by natural drying. After a semi-solid consistency has been reached, drying of the sludge is continued by multiple mechanical turning (DE 19726899 A1; Heinrich Hirdes GmbH, 1998). Next to the conventional dewatering techniques also new techniques can be practiced like a novel technique developed by Ten-Cate whereby a so called “geotube” is used for dewatering of the dredged sludges.

The additional input of water due to weather influences leads to remoistening of the sludges and in this way slows the drying operation. Depending on location, rainfall can cancel out evaporative drying in as many as 8 months of the year. The entire process of sludge conditioning needs up to one year and can be greatly prolonged up to 18 months by higher contents of fine-grained sludge fractions in the size range of 0.06 mm and smaller, since deposits thereof form sediment layers that are almost impervious for water and block seepage through drainage devices (see also Prof. Fritz Gehbauer, Institute for Mechanical Engineering in Construction, Fridericiana University, Imb Veroffentlichung, Series V, No. 20, Floating Dredger Technology, Chapter 3.2. Definitions, page 29). Because of the lower density of fine-grained sludges, the dewatering basins hold less dry substance for the same filling level, meaning that the sludge throughput is reduced compared with coarse-grained sludges. To achieve sufficient vane shear strength, which is necessary for further processing of dried sludge, the fine-grained sludge must be dried to a water content of 60 wt %, whereas coarse-grained sludge already meets the strength requirements at 65 to 70 wt %.

In U.S. Pat. No. 3,312,070 (Daiichi Kogyo Seiyaku Kabushiki Kaisha, 1967), the use of surface-active auxiliaries having a coagulating effect is proposed for recovery of sludges, which without these auxiliaries tend to separate into fine and coarse fractions. This in turn results in different material properties of the recovered sludges. Among other examples in the patent, reaction products of acrylamide and carboxymethylcellulose, polyacrylamide, polyvinyl alcohol, mixtures of polyacrylamide with aniline-urea-formaldehyde resins and sulfomethylated polyacrylamide are used. The auxiliaries are metered into the feed line that transports the sludges to the settling basins.

In EP 346159 A1 (Aoki Corp., 1989), it is stated that the method of conventional sludge dewatering, in which the negatively charged sludge particles are treated with cationic salts or cationic polymers, is disadvantageous in terms of flocculation effectiveness and costs. As an alternative, the successive addition of an anionic and a cationic polymeric coagulating agent and if necessary of a further anionic flocculating agent are proposed for sludge dewatering. Because of the practical circumstances, whereby the flocculating agent is mixed in with the rapid stream of aqueous sludge before it enters the sludge settling basin, it is not guaranteed that two or three different flocculating agents matched to one another can be successfully metered in so that they will interact to form sedimented sludge flocs.

From DE 10333478 A1 a method for the accelerated dehydration of sludges in sludge disposal areas is known, especially of sludges from rivers and harbors, by the use of anionic polymer flocculants.

As a drawback of methods according to the prior art it is not possible that the dosing of the required amount of polymeric flocculating agent is exactly determinable which leads to the disadvantage that the polymeric flocculating agent is overdosed and the free agent is led into the environment and causes enormous dangers to the nature e.g. static waters in lakes. These drawbacks occur e.g. because the sludge can contain various ratios of organics and clay versus sand, but also the absolute amount of sludge to be treated can vary based on the operation conditions of the dredger.

There is a demand for a method that provides an exact dosing of the required amount of polymeric flocculating agent such that an overdosing is prevented and the filtrate can be led into the environment without any dangers caused by free polymeric agents. There is a demand for a method in order to limit the residual amount of the flocculating agent in a filtrate of the sludge. This is in particular important when the filtrate is to be sent directly into the waterway which is being treated, this because of the relatively high fish toxicity of the flocculating agent (e.g. low to medium charged cationic polymers).

It is an object of the invention to provide an alternative method that has advantages when compared with prior art methods.

### SUMMARY OF THE INVENTION

This object is achieved with a method for dewatering of sludge, wherein an aqueous solution of polymeric flocculating agent is added to the sludge, wherein the sludge comprises a component to be removed by the flocculating agent being added to the sludge, wherein in order to limit the residual amount of the flocculating agent in a filtrate of the sludge the method comprises a first step and a second step,

wherein the first step comprises
measuring a first content information related to the solids level in the sludge (i.e. the total (non-dissolving components) inorganic and organic material fraction) and
measuring a second content information related to a sand material content in the sludge, wherein the first and second content information is used to calculate the amount of organic material (for controlling the addition of the aqueous solution of the polymeric flocculating agent to the sludge; because, in practice, only the organic fraction in the sludge will require the cationic polymer to flocculate and dewater),
   wherein the second step comprises measuring a material information related to a material property of the filtrate, wherein the material information is used for controlling the content of the polymeric flocculating agent in the filtrate, wherein the material information comprises the pH-value of the filtrate, wherein in a third step of the method, the pH-value of the filtrate is increased.

Furthermore, this object is achieved with a method for dewatering of sludge, wherein an aqueous solution of polymeric flocculating agent is added to the sludge, wherein the sludge comprises a component to be removed by the flocculating agent being added to the sludge, wherein in order to limit the residual amount of the flocculating agent in a filtrate of the sludge the method comprises a first and/or a second step,

wherein the first step comprises
measuring a first content information related to the solids level in the sludge (i.e. the total (non-dissolving components) inorganic and organic material fraction) and
measuring a second content information related to a sand material content in the sludge, wherein the first and second content information is used to calculate the amount of organic material (for controlling the addition of the aqueous solution of the polymeric flocculating agent to the sludge; because, in practice, only the organic fraction in the sludge will require the cationic polymer to flocculate and dewater),
   wherein the second step comprises measuring a material information related to a material property of the filtrate, wherein the material information is used for controlling the content of the polymeric flocculating agent in the filtrate.

The first content information is a piece of information related to the total (non-dissolving) material content in the sludge, and the second content information is a piece of information related to a sand material content. The first and second content information is being determined by means of measurements, such as the total flow of the sludge, the density of the sludge, solids level of the sludge. The first and second content information are used for controlling the addition of the aqueous solution of the polymeric flocculating agent to the sludge, i.e. the polymeric flocculating agent is added to the sludge in dependency of the first and second content information obtained by measurement during the first step of the inventive method.

The material information is a piece of information related to the filtrate, such as the pH value of the filtrate. The material information is used for controlling the content of the polymeric flocculating agent in the filtrate.

The filtrate is the residual aqueous solution after the dewatering process of the sludge. The filtrate is substantially free from (non-dissolved) organic and sand material.

It has been surprisingly found by using the method according to the invention that in order to avoid leading free polymeric agents into the environment
an exact dosing of the required amount of polymeric flocculating agent (dependent on the first and second content information measured in the first step of the inventive method) is possible such that an overdosing is prevented
   and (if commercially acceptable and ecologically required)
overdosed polymeric flocculating agent (free polymeric agents) can be hydrolyzed by raising the pH-value of the filtrate (requiring the measurement of the material information in the second step of the inventive method),
   with the advantageous result that the filtrate can be led into the environment without any dangers caused by free polymeric agents. This advantage is especially important and valid for a cationic polymeric flocculating agent.

It has been surprisingly found that by executing either the first step or the second step according to the present invention, in order to avoid leading free polymeric agents into the environment,
an exact dosing of the required amount of polymeric flocculating agent (dependent on the first and second content information measured in the first step of the inventive method) is possible such that an overdosing is prevented
   or
overdosed polymeric flocculating agent (free polymeric agents) can be hydrolyzed by raising the pH-value of the filtrate (requiring the measurement of the material information in the second step of the inventive method),
   with the advantageous result that the filtrate can be led into the environment without any dangers caused by free polymeric agents. This advantage is especially important and valid for a cationic polymeric flocculating agent.

In the context of the present invention, it is preferred to use cationic polymers as flocculating agent. One preferred example of such a cationic polymer is an inverse emulsion (Water-in-oil-emulsion) of a cationic copolymer based on acrylamide and methylchloride quaternised dimethylaminoethylacrylate.

With the method according to the present invention, i.e. including the third step of the method (of increasing the pH-value), it is furthermore preferred that during the third step, the pH-value of the filtrate is increased to a level of 9.5, preferably to a level of 10.0, more preferably to a level of 10.8, and still more preferably to a level of 11.0.

Additionally, it is preferred according to the present invention that in a fourth step of the method, the pH-value of the filtrate is neutralized after a residence time (i.e. the pH-value is reduced to a more neutral level such as a level of pH 7 or to pH levels that would be acceptable for the ecosystem where the filtrate is being released to), wherein during the residence time the filtrate has the increased pH-value, wherein preferably the residence time is dependent on the increased pH-value.

Thereby, it is advantageously possible to furthermore avoid leading free polymeric agents into the environment.

The mole ratio between acylamide and the cationic monomer can be 70:30 or 75:25 or 80:20 or 85:15 or 90:10 or 95:5, wherein one preferred mole ratio between acylamide and the cationic monomer is 90:10.

The relevant cationic basis can be described as quaternary and salt products of dialkyl amino alkylacrylate and dialkyl amino alkylmethacrylate and co and/or ter polymers with acrylamide and/or methacrylamide.

One example of such a cationic polymer is Drewfloc 2418 (i.e. an inverse emulsion of a cationic copolymer based on acrylamide and methylchloride quaternised dimethylaminoethylacrylate having a mole ratio between acylamide and the cationic monomer of 90:10).

In the following, the present invention is for the sake of illustration described exemplarily by further embodiments. But it will be understood by any person skilled in the art that other modifications or varieties of the invention are possible without departing from the broader spirit of the invention. Such modifications are therefore to be considered as falling within the spirit and the scope of the invention and hence forming part of the invention as herein described or exemplified. Accordingly the exemplary description is to be regarded in an illustrative sense rather than in a restrictive sense.

According to a preferred embodiment the method comprises adjusting the level of polymeric flocculating agent based upon the measured first and second content information and/or material information. The feed rate of polymer is preferably increased if the content of organic material is rising and decreased if the content of organic material is decreasing. More preferably the feed rate of polymer is decreased if the content of cationic polymer is rising in the filtrate.

According to a preferred embodiment the first and second content information is determined comprising the steps of measuring the total flow of the sludge, measuring the density of the sludge and measuring the solids level in the sludge. Thereby, it is advantageously possible to determine the first content information (related to the total solids level (i.e. the (non-dissolving) organic and inorganic material content) in the sludge) and the second content information (related to the sand material content in the sludge) by measuring both
the solids level in the sludge (i.e. indicative of the total amount of solids in the sludge, comprising both the organic material and the sand material), and
the density of the sludge (providing an indication of the density of the solid material and hence (due to the fact that the typical specific weight of the organic material and the typical specific weight of the sand material are known or at least not greatly varying) an indication of the amount of sand material in the sludge).

According to a further preferred embodiment the method further comprises adjusting the concentration of the sludge to a pumpable concentration by addition of water, preferably while the sludge is being transported, wherein preferably the method further comprises flushing the sludge through a pipeline to a dewatering field.

According to a further preferred embodiment the method further comprises allowing the sludge to settle in the dewatering field to form a sediment and partly freeing the sludge of supernatant and/or drainage water and then subjecting the sludge to natural evaporative drying.

According to a further preferred embodiment the first and second content information is determined using a programmable logic controller.

According to a further preferred embodiment the total flow of the sludge is measured using an electromagnetic flow meter.

According to a further preferred embodiment the density of the sludge is measured using a radiometric density meter.

According to a further preferred embodiment the solid level in the sludge is measured using an optical immersion sensor.

According to a further preferred embodiment, the material information comprises the pH-value of the filtrate, wherein in a third step of the inventive method, the pH-value of the filtrate is increased, preferably to a level of 9.5, more preferably to a level of 10.0, still more preferably to a level of 10.8, and most preferably to a level of 11.0.

According to a further preferred embodiment, in a fourth step of the inventive method, the pH-value of the filtrate is neutralized after a residence time, wherein during the residence time the filtrate comprises the increased pH-value, wherein preferably the residence time is dependent on the increased pH-value.

A further object of the present invention refers to an apparatus for dewatering of sludge the apparatus comprising a measuring unit, a controlling unit and a dosing unit, wherein the measuring unit is configured for determining a first content information related to the solids level (i.e. to the organic and inorganic material content) in the sludge, and for determining a second content information related to a sand material content in the sludge, wherein the controlling unit is configured for controlling the dosing unit depending on the first and second content information, wherein the dosing unit is configured for adding an aqueous solution of a polymeric flocculating agent to the sludge, wherein the measuring unit is furthermore configured for measuring a material information related to a material property of the filtrate, wherein the apparatus is configured for controlling the content of the polymeric flocculating agent in the filtrate in dependency of the material information, wherein the material information comprises the pH-value of the filtrate, wherein the apparatus is furthermore configured to increase the pH-value of the filtrate subsequent to filtration.

A still further object of the present invention refers to an apparatus for dewatering of sludge the apparatus comprising a measuring unit, a controlling unit and a dosing unit, wherein the measuring unit is configured for determining a first content information related to the solids level (i.e. to the organic and inorganic material content) in the sludge, and for determining a second content information related to a sand material content in the sludge, wherein the controlling unit is configured for controlling the dosing unit depending on the first and second content information, wherein the dosing unit is configured for adding an aqueous solution of a polymeric flocculating agent to the sludge.

According to a further preferred embodiment the measuring unit comprises an electromagnetic flow meter for measuring the total flow of the sludge.

According to a further preferred embodiment the measuring unit comprises a radiometric density meter for measuring the density of the sludge.

According to a further preferred embodiment the measuring unit comprises an optical immersion sensor or other commercially available technique for measuring the solids level of the sludge.

According to a further preferred embodiment the dosing unit is configured for adding the aqueous solution of the polymeric flocculating agent to the sludge during transportation of the sludge, preferably during transportation of the sludge in a pipeline.

### BRIEF DESCRIPTION OF THE DRAWINGS

FIG. 1 shows schematically an exemplary embodiment of an apparatus according to the present invention.

### DETAILED DESCRIPTION OF THE INVENTION

Through this invention it is possible to dose a polymer dependent on the amount of organic material present in a dredging sludge, preferably to dose the polymer proportional to the amount of organic material. Not only is the polymer now used efficiently, also the overdosing of polymer is prevented. Overdosing of polymer will lead to free (cationic) polymer being released to the environment with the associated risk of fish kill. According to the present invention it is advantageously possible to measure in any sludge stream (to be supplied by the dredging operation) the actual amount of organic material and to use this value to dose the cationic polymer proportional to this.

When dredging (harbor) sludge the flow of material (water, sand, clay, organic) will greatly depend on how the dredging boat is being operated and what the nature of the dredged material would be. The amount and/or type of materials that are being transported to the geotube for dewatering comprise a mixture of water, sand and organic material. For optimal dewatering results, sufficient polymer must be dosed, but the big danger is that a large part of the time the polymer is being underfed (resulting in a not complete dewatering) or overfed (resulting in free polymer being released to the environment). In particular this last case results in big dangers for the nature e.g. for lakes, rivers and/or seas.

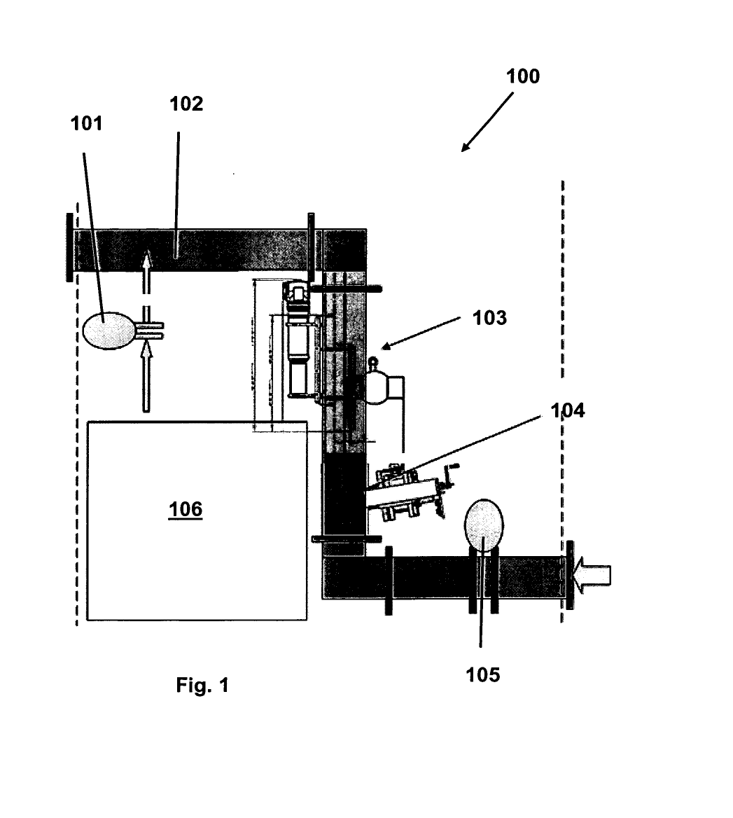

The solids in a dredging sludge contain sand (which will not or only slightly react with the cationic polymer) and organic material (which will react with the cationic flocculating agent). The total flow of sludge is typically stable. FIG. 1 depicts an apparatus 100 according to an exemplary embodiment of the present invention. The total flow of sludge in a pipeline 102 can be measured reliably using an electromagnetic flow meter 105 whereby the flow meter is preferably protected by a rubber lining. The density of the sludge can be measured reliably using a radiometric density meter 103. The measurement, using preferably an optical immersion sensor 104, reliably measures the solids level in the sludge. The sand fraction in the sludge is the factor that influences the density of the sludge most considerably.

According to the present invention it is advantageously possible that the amount of polymer will react completely with the organic material and clay particles when dosed in proportion. The flow of sludge (measured, e.g., in cubic meters per second (m³/s) or a multiple or fraction thereof), the density of the sludge (measured, e.g., in kilograms per cubic meter (kg/m³) or a multiple or fraction thereof) and the solids level in the sludge (measured, e.g., by the percentage of the volume of solids compared to the total volume of the sludge or by the percentage of the weight of solids compared to the total weight of the sludge) are monitored continuously. From the density of the sludge, the amount (i.e. the percentage) of sand is being calculated (second content information). This percentage is being deducted from the measured amount of total solids in the sludge (first content information). The result of this is equal to (or corresponds at least approximately to) the fraction of organic material in the sludge. The flow of sludge multiplied by this percentage (i.e. the fraction of organic material in the sludge) is equal to the amount of organic material per time.

For example, the flow F of sludge, the density D of the sludge and the solids level S in the sludge are measured. The density of water w, organic material o and sand s are well known. The total solids comprise a percentage of organic material and a percentage of sand/clay. Therefore there are three equations and three unknown variables: the content of sand in the sludge, the content of organic material in the sludge and the content of water in the sludge, which leads to a solvable problem.

Preferably the calculations will be made using a programmable logic controller (PLC), more preferably with a touch screen. According to the present invention, it is advantageously possible to dose the polymer proportional to the calculated value in a dosing unit 101 and prevent under dosing and over dosing of polymer through exact dosing. Preferably the apparatus 100 further comprises a polymer dissolving unit 106. Preferably the dosing unit 101 comprises an electromagnetic flow meter that is optionally installed in the polymer injection line. Advantageously it is possible to monitor the actual amount of polymer solution that is being dosed to the sludge, knowing the sludge flow, and the solids level. It is then possible to accurately calculate the amount of polymer (kg) dosed per MT of dry sludge. The output from the PLC is controlling the speed of the polymer solution pump which determines the necessary amount of polymer added.

An alternative or an optional embodiment of the present invention is a method for dewatering of sludge, the method comprising the steps of adding an aqueous solution of polymeric flocculating agent to the sludge, wherein a material information related to a material property of a filtrate is determined, wherein the material information is used for controlling the content of the polymeric flocculating agent in the filtrate. Therefore it is advantageously possible to avoid leading filtrate with free polymeric agents into the environment.

In the following, conducted examples are presented. These examples refer to the second step, wherein the second step comprises measuring a material information related to a material property of the filtrate being determined, wherein the material information is used for controlling the content of the polymeric flocculating agent in the filtrate. The material information comprises in the following examples the pH-value of the filtrate, wherein the pH-value of the filtrate is increased to a predetermined level. The increased pH-value of the filtrate is neutralized after a residence time (i.e. the pH-value is reduced to a more neutral level such as a level of pH 7 or to pH levels that would be acceptable for the ecosystem where the filtrate is being released to), wherein during the residence time the filtrate comprises the increased pH-value.

### Examples 1 to 3

In the following examples, the cationic polymer Drewfloc 2418 is used. A flocculating agent (Drewfloc 2418, 10 mol/22 weight % cationic emulsion polymer based on Adame-Quat (methylchloride quaternised dimethylaminoethylacrylate) and acrylamide) is used to provide a 0.1% aqueous solution of Drewfloc 2418 in desalinated water. Then this solution was used to provide a 25 ppm Drewfloc 2418 polymer test solution by means of using 975 g of tap-water and 25 g of the 0.1% aqueous solution of Drewfloc 2418. This test solution is provided three times.

For a first example, 3.2 g NaOH (20%) is added to the test solution for obtaining a pH value of 11.5.

For a second example, 2.0 g NaOH (20%) is added to the test solution for obtaining a pH value of 11.0.

For a third example, the pH value of the test solution is not changed.

After three hours of storage, experiments using a clay suspension have been performed. The solutions of the three examples of test solutions showed a strong flocculation of the clay suspension

After three days of further storage, experiments using a particle charge detector produced by the company Mütek have been conducted using the three test solutions and it was found that the ionogenity of the solutions has been strongly anionic.

### Examples 4 to 12

The a.m. polymer test solution containing 25 ppm Drewfloc 2418 has been used to provide solutions of different pH values using different amounts of NaOH (20% solution) or Ca(OH)₂ (100 g/l). These solutions having different pH values have been measured using the Mütek particle charge detector. The results concerning the ionogenity are presented in the following table:

The first column gives the number of the example. In the second column, the obtained pH value is given. The third column specifies the amount of NaOH (20% solution) or Ca(OH)₂ (100 g/l) added, and the fourth column gives the duration of storage in minutes. The fifth column specifies the ionogenity.

| | | | | |
|---|---|---|---|---|
| 4 | 8.0 | 0.2 g NaOH (20%) | 50 | cationic |
| 5 | 9.0 | 0.61 g NaOH (20%) | 50 | cationic |
| 6 | 9.0 | 0.61 g NaOH (20%) | 300 | cationic |
| 7 | 9.0 | 0.61 g NaOH (20%) | 1440 | anionic |
| 8 | 10.0 | 1.65 g NaOH (20%) | 50 | anionic |
| 9 | 9.0 | 2.4 Ca(OH)₂ (100 g/l) | 60 | cationic |
| 10 | 9.0 | 2.4 Ca(OH)₂ (100 g/l) | 120 | cationic |
| 11 | 9.5 | 3.75 Ca(OH)₂ (100 g/l) | 80 | anionic |
| 12 | 11.0 | 5.4 Ca(OH)₂ (100 g/l) | 10 | anionic |

### Examples 13 to 16

Examples to test the degradation of cationic activity have been conducted using a filtrate from a Geotube installation in Herzogenrath, Germany. A cross linked polymer, Zetag 8848 FS (BASF, CIBA) has been used. The filtrate water contained approximately 20 ppm of this product. This filtrate water has been used for the following examples (using 1500 g of the filtrate water in the examples). The results concerning the ionogenity are presented in the following table:

The first column gives the number of the example. In the second column, the obtained pH value is given. The third column specifies the amount of NaOH (20% solution) or Ca(OH)₂ (100 g/l) added (if applicable), and the fourth column gives the duration of storage in hours. The fifth column specifies the ionogenity.

| | | | | |
|---|---|---|---|---|
| 13 | 9.0 | 0.67 g Ca(OH)₂ (100 g/l) | 18 | cationic |
| 14 | 9.5 | 0.61 g Ca(OH)₂ (100 g/l) | 18 | anionic |
| 15 | 10.0 | 0.61 g Ca(OH)₂ (100 g/l) | 18 | anionic |
| 16 | 7.5 | Original filtrate water | 18 | cationic |

### Examples 17 to 22

Further experiments have been conducted to find solutions to reduce the time of storage to about 1 minute (60 seconds) and to still eliminated the cationic change measured with the particle charge detector produced by the company Mütek.

For the examples 17 to 22, again the flocculating agent (Drewfloc 2418, 10 mol/22 weight % cationic emulsion polymer based on Adame-Quat (methylchloride quaternised dimethylaminoethylacrylate) and acrylamide) is used to provide a 0.1% aqueous solution of Drewfloc 2418 in desalinated water. Then this solution was used to provide a 25 ppm Drewfloc 2418 polymer test solution by means of using 975 g of tap-water and 25 g of the 0.1% aqueous solution of Drewfloc 2418. This test solution is provided for all the examples 17 to 22.

These different polymer test solutions containing 25 ppm Drewfloc 2418 have been used to provide solutions of different pH values using different amounts of NaOH (20% solution). These solutions having different pH values have been measured using the Mütek particle charge detector. The results concerning the ionogenity are presented in the following table:

The first column gives the number of the example. In the second column, the obtained pH value is given. The third column specifies the amount of NaOH (20% solution) added, and the fourth column gives the duration of storage in seconds. The fifth column specifies the ionogenity.

| | | | | |
|---|---|---|---|---|
| 17 | 11.6 | 3.2 g NaOH (20%) | 60 | anionic |
| 18 | 11.4 | 2.45 g NaOH (20%) | 60 | anionic |
| 19 | 11.2 | 2.0 g NaOH (20%) | 60 | anionic |
| 20 | 11.0 | 1.7 g NaOH (20%) | 60 | anionic |
| 21 | 10.4 | 1.35 g NaOH (20%) | 60 | cationic |
| 22 | 10.4 | 1.35 g NaOH (20%) | 300 | anionic |

### LIST OF REFERENCE SIGNS

100 apparatus
101 dosing unit
102 pipeline
103 radiometric density meter
104 optical immersion sensor
105 electromagnetic flow meter
106 polymer dissolving unit

1. A method for dewatering sludge, comprising:
adding an aqueous solution of polymeric flocculating agent to the sludge, wherein the sludge comprises a component to be removed by the flocculating agent;
limiting a residual amount of the flocculating agent in a filtrate of the sludge by (i) measuring a first content information related to a solids level in the sludge and (ii) measuring a second content information related to a sand material content in the sludge;
controlling the addition of the aqueous solution of the polymeric flocculating agent to the sludge based on the first and second content information;
measuring a material information related to a material property of the filtrate;
controlling the content of the polymeric flocculating agent in the filtrate based on the material information, wherein the material information comprises the pH-value of the filtrate; and
increasing the pH-value of the filtrate.

2. The method of claim 1, comprising adjusting the addition of polymeric flocculating agent based on at least one information selected from the group consisting of the first content information, the second content information and the material information.

3. The method of claim 1, wherein the first and second content information is determined
measuring a total flow of the sludge,
measuring a density of the sludge, and
measuring the solids level in the sludge.

4. The method of claim 1 further comprising adjusting a concentration of the sludge to a pumpable concentration by adding water.

5. The method of claim 4, further allowing the sludge to settle in a dewatering field to form a sediment and partly freeing the sludge of supernatant, drainage water, or both, and then subjecting the sludge to natural evaporative drying.

6. The method of claim 1, wherein a the first and second content information is determined by employing a programmable logic controller.

7. The method of claim 1, wherein a total flow of the sludge is measured using an electromagnetic flow meter.

8. The method of claim 1, wherein a density of the sludge is measured using a radiometric density meter.

9. The method of claim 1, wherein the solids level in the sludge is measured using an optical immersion sensor.

10. The method of claim 1, wherein the pH-value of the filtrate is increased to a level of 9.5.

11. The method of claim 1, further comprising maintaining the increased pH-value of the filtrate for a residence time, then neutralizing the pH-value of the filtrate after the residence time.

12. An apparatus suitable for dewatering sludge, the apparatus comprising a measuring unit, a controlling unit and a dosing unit, wherein the measuring unit is configured for determining a first content information related to a solids level in the sludge, and for determining a second content information related to a sand material content in the sludge, wherein the controlling unit is configured for controlling the dosing unit depending on the first and second content information, wherein the dosing unit is configured for adding an aqueous solution of a polymeric flocculating agent to the sludge, wherein the measuring unit is furthermore configured for measuring a material information related to a material property of the filtrate wherein the apparatus is configured for controlling the content of the polymeric flocculating agent in the filtrate in dependency of the material information, wherein the material information comprises the pH-value of the filtrate, wherein the apparatus is furthermore configured to increase the pH-value of the filtrate subsequent to filtration.

13. The apparatus of claim 12, wherein the apparatus is furthermore configured
to provide a residence time, during which the filtrate has the increased pH-value, and
to neutralize the pH-value of the filtrate after the residence time.

14. The apparatus of claim 12, wherein the measuring unit comprises at least one selected from the group consisting of
an electromagnetic flow meter configured to measure a total flow of the sludge,
a radiometric density meter configured to measure a density of the sludge, and
an optical immersion sensor configured to measure the solids level of the sludge.

15. The apparatus of claim 12, wherein the dosing unit is configured for adding the aqueous solution of the polymeric flocculating agent to the sludge during transportation of the sludge.

16. The method of claim 4, wherein the water is added while the sludge is being transported.

17. The method of claim 4, further comprising flushing the sludge through a pipeline to a dewatering field.

18. The method of claim 1, wherein the pH-value of the filtrate is increased to a level of 10.0.

19. The method of claim 1, wherein the pH-value of the filtrate is increased to a level of 10.8.

20. The method of claim 1, wherein the pH-value of the filtrate is increased to a level of 11.0.
